(19) United States
(12) Patent Application Publication
(10) Pub. No.: US 2019/0130898 A1
(43) Pub. Date: May 2, 2019

(54) WAKE-UP-WORD DETECTION

(71) Applicant: GM Global Technology Operations LLC, Detroit, MI (US)

(72) Inventors: Eli Tzirkel-Hancock, Ra'anana (IL); Oana Sidi, Ramat Hasharon (IL)

(21) Appl. No.: 15/801,663

(22) Filed: Nov. 2, 2017

(51) Int. Cl. G10L 15/08; G10L 15/22

(52) U.S. Cl. CPC G10L 15/08; G06F 9/4418; G10L 2015/088; G10L 15/22

(57) ABSTRACT

Examples of techniques for wake-up-word detection are disclosed. In one example implementation, a computer-implemented method includes receiving, by a processing device, an utterance from a user. The method further includes streaming, by the processing device, the utterance to each of a plurality of digital assistants. The method further includes monitoring, by the processing device, an activity of at least one of the plurality of digital assistants to determine whether any of the plurality of digital assistants recognize the utterance as a wake-up-word. The method further includes, responsive to determining that one of the plurality of digital assistants recognize the utterance as a wake-up-word, disabling, by the processing device, streaming of additional utterances to a subset of the plurality of digital assistants that do not recognize the utterance as a wake-up-word.

### INTRODUCTION

The present disclosure relates generally to speech recognition and speech synthesis and more particularly to wake-up-word detection.

Speech recognition (or “automated speech recognition” (ASR)) enables computing devices to recognize spoken language and translate the spoken language into text or intentions. ASR enabled computing devices can receive spoken language input from a user and translate the spoken language input into text that the computing device can understand. This enables, for example, the computing device to implement an action when it receives a spoken language input. For example, if a user says “call home,” a computing device enabled with ASR may recognize and translate the phrase and initiate a call. ASR can be triggered by the detection of a single word or phrase referred to as a “wake-up-word” (WUW) that, when spoken by a user, is detected by an ASR enabled computing device to trigger the ASR.

### SUMMARY

In one exemplary embodiment, a computer-implemented method for wake-up-word (WUW) detection includes receiving, by a processing device, an utterance from a user. The method further includes streaming, by the processing device, the utterance to each of a plurality of digital assistants. The method further includes monitoring, by the processing device, an activity of at least one of the plurality of digital assistants to determine whether any of the plurality of digital assistants recognize the utterance as a wake-up-word. The method further includes, responsive to determining that one of the plurality of digital assistants recognize the utterance as a wake-up-word, disabling, by the processing device, streaming of additional utterances to a subset of the plurality of digital assistants that do not recognize the utterance as a wake-up-word.

In some examples, at least one of the plurality of digital assistants is a phone-based digital assistant. In some examples, at least one of the plurality of digital assistants is a vehicle-based digital assistant. In some examples, the vehicle-based digital assistant can control at least one of a telematics system of a vehicle, an infotainment system of the vehicle, and a communication system of the vehicle. In some examples, monitoring the activity of at least one of the plurality of digital assistants further comprises detecting whether at least one of the plurality of digital assistants is performing a speech activity. In some examples, monitoring the activity of at least one of the plurality of digital assistants further comprises detecting whether at least one of the plurality of digital assistants is performing a music activity. In some examples, disabling the streaming of additional utterances to a subset of the plurality of digital assistants is based at least in part on an activity classification of the one of the plurality of digital assistants that recognize the utterance as a wake-up-word. In some examples, streaming of additional utterances to the subset of the plurality of digital assistants is disabled when the activity classification is a first activity classification, and streaming of additional utterances to the subset of the plurality of digital assistants is enabled when the activity classification is a second activity classification. In some examples, the first activity classification is a phone call or text narration, and wherein the second activity classification is playing music. According to aspects of the present disclosure, the method further includes, responsive to determining that the one of the plurality of digital assistants that recognize the utterance as a wake-up-word is no longer active, enabling, by the processing device, streaming of additional utterances to the plurality of digital assistants. In some examples, the activity of at least one of the plurality of digital assistants is provided by the at least one of the plurality of digital assistants, and wherein the activity comprises an activity status and an activity type.

In another exemplary embodiment, a system for wake-up-word (WUW) detection includes a memory including computer readable instructions and a processing device for executing the computer readable instructions for performing a method. In examples, the method includes receiving, by a processing device, an utterance from a user. The method further includes streaming, by the processing device, the utterance to each of a plurality of digital assistants. The method further includes monitoring, by the processing device, an activity of at least one of the plurality of digital assistants to determine whether any of the plurality of digital assistants recognize the utterance as a wake-up-word. The method further includes, responsive to determining that one of the plurality of digital assistants recognize the utterance as a wake-up-word, disabling, by the processing device, streaming of additional utterances to a subset of the plurality of digital assistants that do not recognize the utterance as a wake-up-word.

In some examples, at least one of the plurality of digital assistants is a phone-based digital assistant. In some examples, at least one of the plurality of digital assistants is a vehicle-based digital assistant. In some examples, the vehicle-based digital assistant can control at least one of a telematics system of a vehicle, an infotainment system of the vehicle, and a communication system of the vehicle. In some examples, monitoring the activity of at least one of the plurality of digital assistants further comprises detecting whether at least one of the plurality of digital assistants is performing a speech activity. In some examples, monitoring the activity of at least one of the plurality of digital assistants further comprises detecting whether at least one of the plurality of digital assistants is performing a music activity. In some examples, disabling the streaming of additional utterances to a subset of the plurality of digital assistants is based at least in part on an activity classification of the one of the plurality of digital assistants that recognize the utterance as a wake-up-word. In some examples, streaming of additional utterances to the subset of the plurality of digital assistants is disabled when the activity classification is a first activity classification, streaming of additional utterances to the subset of the plurality of digital assistants is enabled when the activity classification is a second activity classification, and the first activity classification is a phone call or text narration, and wherein the second activity classification is playing music.

In yet another exemplary embodiment a computer program product for wake-up-word (WUW) detection includes a computer readable storage medium having program instructions embodied therewith, the program instructions executable by a processing device to cause the processing device to perform a method. In examples, the method includes receiving, by a processing device, an utterance from a user. The method further includes streaming, by the processing device, the utterance to each of a plurality of digital assistants. The method further includes monitoring, by the processing device, an activity of at least one of the plurality of digital assistants to determine whether any of the plurality of digital assistants recognize the utterance as a wake-up-word. The method further includes responsive to determining that one of the plurality of digital assistants recognize the utterance as a wake-up-word, disabling, by the processing device, streaming of additional utterances to a subset of the plurality of digital assistants that do not recognize the utterance as a wake-up-word.

The above features and advantages, and other features and advantages of the disclosure are readily apparent from the following detailed description when taken in connection with the accompanying drawings.

### BRIEF DESCRIPTION OF THE DRAWINGS

Other features, advantages, and details appear, by way of example only, in the following detailed description, the detailed description referring to the drawings in which:

FIG. 1 depicts a processing system for wake-up-word (WUW) detection, according to aspects of the present disclosure;

FIG. 2 depicts a block diagram of a sniffer engine for wake-up-word (WUW) detection, according to aspects of the present disclosure;

FIG. 3 depicts a flow diagram of a method for wake-up-word (WUW) detection, according to aspects of the present disclosure;

FIG. 4 depicts a flow diagram of a method for wake-up-word (WUW) detection, according to aspects of the present disclosure; and

FIG. 5 depicts a block diagram of a processing system for implementing the techniques described herein, according to aspects of the present disclosure.

The above features and advantages, and other features and advantages of the disclosure are readily apparent from the following detailed description when taken in connection with the accompanying drawings.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The technical solutions described herein provide for wake-up-word (WUW) detection. In particular, the technical solutions provided herein enable a user to access a desired digital assistant (e.g., a smartphone assistant, a vehicle assistant, etc.) using a wake-up-word. For example, in a vehicle, a user can have access to a phone assistant, an embedded vehicle assistant, or another assistant. Wake-up-words can be used to access the various digital assistants. In some cases, each digital assistant can be activated by the user uttering the wake-up-word for that assistant.

In existing implementations, a user may be required to select a default digital assistant, and changing between digital assistants can be cumbersome to the user. In the vehicle setting, one possible implementation includes a vehicle's automated speech recognition (ASR) system detecting an utterance from a user and making a determination of whether the utterance is a WUW. If it is determined to be a WUW, the ASR system directs the WUW (and a subsequent command, if any), to the appropriate digital assistant based on the WUW. However, WUW detection techniques can cause inconsistencies between the plurality of digital assistants and/or an individual digital assistant can perform its own detection of a WUW. These current techniques can, therefore, cause confusion among the digital assistants. A failure by the ASR system to detect a WUW or to activate the correct digital assistant can lead to poor performance, poor user experience, and poor perception of the value of the system to the user.

Another option to attempt to reconcile and correct these inconsistencies requires a user to press a button to trigger an assistant instead of using a WUW. For example, a short button press triggers one digital assistant (e.g., a smartphone's digital assistant) and a long button press triggers another digital assistant (e.g., the vehicle's digital assistant).

The techniques described herein address these shortcomings by continuously streaming utterances to multiple digital assistants to make use of the assistants' optimized WUW detectors for best performance and to avoid inconsistency with WUW detection in the vehicle's ASR system. The present techniques also intelligently monitor assistant activity to enable mutual exclusion of other digital assistants. It should be appreciated that the techniques described herein can be applied to or implemented in any suitable technology or devices, such as Internet of Things objects (e.g., smartphones, smart TVs, home speakers, thermostats, etc.).

The term Internet of Things (IoT) object is used herein to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other objects over a wired or wireless connection. An IoT object can have a passive communication interface, such as a quick response (QR) code, a radio-frequency identification (RFID) tag, a near field communication (NFC) tag, or the like, or an active communication interface, such as a modem, a transceiver, a transmitter-receiver, or the like. An IoT object can have a particular set of attributes (e.g., a device state or status, such as whether the IoT object is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT objects can include, but are not limited to, vehicles, vehicle components, vehicle systems and sub-systems, refrigerators, toasters, ovens, microwaves, freezers, dishwashers, dishes, hand tools, clothes washers, clothes dryers, furnaces, heating, ventilation, air conditioning & refrigeration (HVACR) systems, air conditioners, thermostats, smart televisions, fire alarm & protection system, fire/smoke and carbon dioxide detectors, access/video security system, elevator and escalator systems, burner and boiler controls, building management controls, televisions, light fixtures, vacuum cleaners, sprinklers, electricity meters, gas meters, etc., so long as the devices are equipped with an addressable communications interface for communicating with the IoT network. IoT objects can also include cell phones, desktop computers, laptop computers, tablet computers, personal digital assistants (PDAs), etc. Accordingly, the IoT network can include a combination of “legacy” Internet-accessible devices (e.g., laptop or desktop computers, cell phones, etc.) in addition to devices that do not typically have Internet-connectivity (e.g., dishwashers, etc.).

According to an example of the present disclosure, wake-up-word detection is provided. An utterance is received from a user and streamed to a plurality of digital assistants. The activity of the digital assistants is monitored to determine whether (and if so, which) of the digital assistants recognize the utterance as a wake-up-word. Responsive to one of the digital assistants recognizing the WUW, streaming to the other digital assistants is disabled.

Example embodiments of the disclosure include or yield various technical features, technical effects, and/or improvements to technology. Example embodiments of the disclosure provide techniques for wake-up-word detection by streaming an utterance to multiple digital assistants, monitoring the activity of the digital assistants to determine whether any recognize the utterance as a wake-up-word, and then disabling streaming to other digital assistants when one of the digital assistants is active (i.e., recognizes the wake-up-word). These aspects of the disclosure constitute technical features that yield the technical effect of enabling multiple digital assistants while reducing confusion among multiple digital assistants, enhancing user experience when using wake-up-words with digital assistants, preventing activation of an incorrect digital assistant, and the like. The present techniques also help prevent false detection, such as by a vehicle's ASR system, of a wake-up-word, which improves the overall digital assistant interaction. As a result of these technical features and technical effects, wake-up-word detection in accordance with example embodiments of the disclosure represents an improvement to existing digital assistant, wake-up-word, and ASR technologies. Moreover, computing systems implementing the present techniques are improved by using less memory and processing resources as a result of reduced misdetection of wake-up-words and disabling or deactivating multiple streaming. It should be appreciated that the above examples of technical features, technical effects, and improvements to the technology of example embodiments of the disclosure are merely illustrative and not exhaustive.

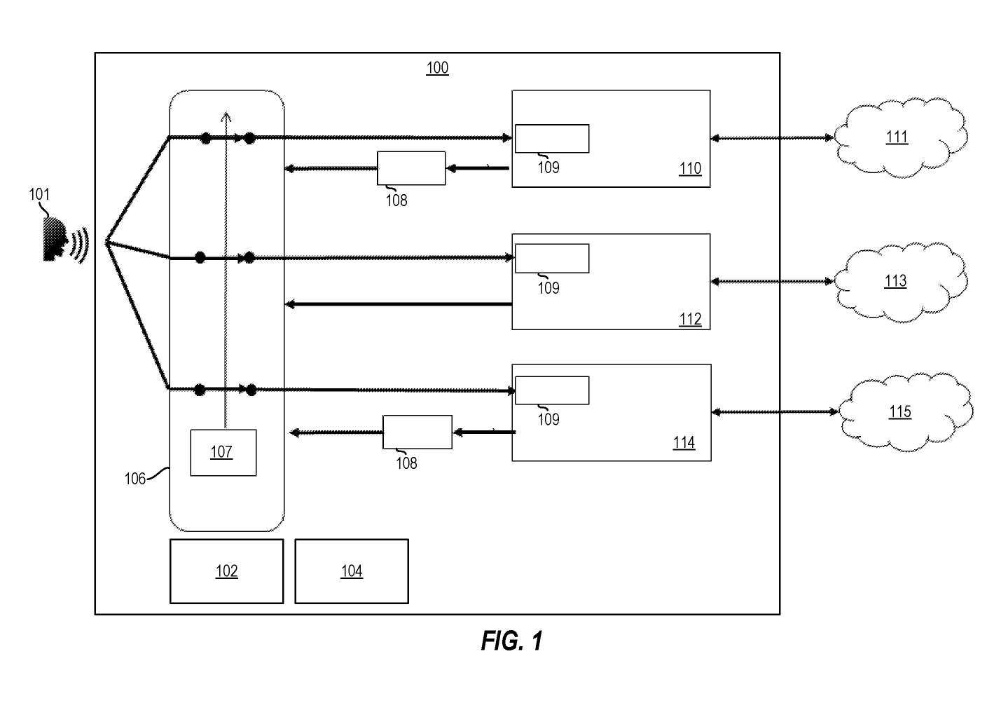

FIG. 1 depicts a processing system 100 for wake-up-word (WUW) detection, according to aspects of the present disclosure. The processing system 100 includes a processing device 102, a memory 104, an audio bridge engine 106, a first assistant client 110, a second assistant client 112, a third assistant client 114, and sniffer engines 108.

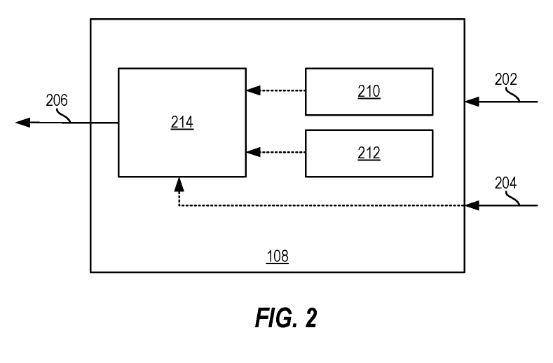

The various components, modules, engines, etc. described regarding FIG. 1 (and FIG. 2 described herein) can be implemented as instructions stored on a computer-readable storage medium, as hardware modules, as special-purpose hardware (e.g., application specific hardware, application specific integrated circuits (ASICs), as embedded controllers, hardwired circuitry, etc.), or as some combination or combinations of these.

In examples, the engine(s) described herein can be a combination of hardware and programming. The programming can be processor executable instructions stored on a tangible memory, and the hardware can include the processing device 102 for executing those instructions. Thus a system memory (e.g., the memory 104) can store program instructions that when executed by the processing device 102 implement the engines described herein. Other engines can also be utilized to include other features and functionality described in other examples herein. Alternatively or additionally, the processing system 100 can include dedicated hardware, such as one or more integrated circuits, ASICs, application specific special processors (ASSPs), field programmable gate arrays (FPGAs), or any combination of the foregoing examples of dedicated hardware, for performing the techniques described herein.

The audio bridge engine 106 receives an utterance from a user 101. The utterance can be a word, phrase, or other vocal sound detected, such as by a microphone (not shown) of the processing system 100. The audio bridge engine 106 streams the utterance to the first, second, and third assistant clients 110, 112, 114. The assistant clients 110, 112, 114 can interact with various digital assistants, such as a phone assistant 111, a car assistant 113, another assistant 115, or any other suitable digital assistant. By streaming the utterance, which may or may not be a WUW, the audio bridge engine 106 can make the best use of the assistants' 111, 113, 115 WUW detections and avoid inconsistency in WUW detection.

Each of the assistant clients 110, 112, 114 receives the utterance 109. However, it should be appreciated that the utterance may or may not be a WUW. The utterance 109 is received at each of the assistant clients 110, 112, 114 from the audio bridge engine 106, and the utterance 109 is sent to the respective digital assistants 111, 113, 115. For example, the first assistant client 110 sends the utterance 109 to the phone assistant 111, the second assistant client 112 sends the utterance 109 to the car assistant 113, and the third assistant client 114 sends the utterance 109 to the assistant 115.

Once the digital assistants 111, 113, 115 receive the utterance 109, each of the digital assistants 111, 113, 115 individually determines whether the utterance 109 is a WUW. The digital assistant 111, 113, 115 that determines that the utterance 109 is a WUW for that digital assistant is referred to as an “active” assistant, and the active assistant can take an action based on the WUW. For example, the active assistant can provide a visual/auditory/tactile reply to the user 101, can await additional utterances that may include commands, and the like.

A sniffer engine 108 can be located between the audio bridge engine 106 and the respective assistant client. In the example of FIG. 1, a sniffer engine 108 is located between the audio bridge engine 106 and the first assistant client 110 and between the audio bridge engine 106 and the third assistant client 114. A sniffer engine is not located between the audio bridge engine 106 and the second assistant client 112 in the example of FIG. 1 because, for example, the second assistant client 112 can directly indicate its activity to the audio bridge engine 106 without a sniffer engine. However, in other examples, a sniffer engine could be implemented between the audio bridge engine 106 and the second assistant client 112.

The sniffer engine 108 monitors assistant activity to enable exclusion of other assistants so that only a single digital assistant is active at a time. For example, the sniffer engine 108 can receive a response from the first assistant client 110 when the smartphone assistant 111 becomes active, and the sniffer 108 can indicate to the audio bridge engine 106 that the phone assistant 111 is active. This causes the audio bridge engine 106 to deactivate, via the logic 107, communicative connections between the audio bridge and the other assistant clients (e.g., the second assistant client 112 and the third assistant client 114). Accordingly, any future utterances from the user 101 are passed only to the active assistant (e.g., the phone assistant 111). This prevents other deactivated assistants (e.g., the car assistant 113 or the assistant 115) from interfering or implementing any actions. In some examples, the communicative connection in the audio bridge engine 106 for the deactivated assistants can remain inactive until the active assistant is no longer active, for a predetermined period of time, during a specific activity type, etc.

FIG. 2 depicts a block diagram of a sniffer engine 108 for wake-up-word (WUW) detection, according to aspects of the present disclosure. The sniffer engine 108 receives audio 202 from a digital assistant (e.g., one of the digital assistants 111, 113, 115). The sniffer engine 108 can also receive other modality information 204, such as text or graphic user interface widget actions, or image, from the digital assistant. The sniffer engine 108 can use the audio 202 and/or the other modality information 204 to determine an assistant activity 206, which is sent to the audio bridge engine 106, which indicates to the audio bridge engine 106 whether the digital assistant associated with the sniffer engine 108 is active or inactive.

The sniffer 108 includes an activity classification engine 214 to determine the assistant activity 206. For example, the activity classification engine 214 can receive information from a speech detection engine 210 and/or a music detection engine 212. The speech detection engine 210 detects a speech activity from the assistant (e.g., driving directions, text narration, etc.), and the music detection engine 212 detects whether a music activity is being performed (e.g., whether music is being played by the assistant). In an example, if speech activity is detected, the sniffer 108 can indicate that the associated assistant is active, which closes the audio bridge engine 106 to the other assistants. In another example, if music activity is detected, the sniffer 108 can indicate that the associated assistant is not active, which leaves the audio bridge engine 106 open to the other assistants. This enables the user 101 to play music, for example, from one device (running one assistant) while other devices (running other assistants) remain alert and ready to receive a wake-up-word from the user 101.

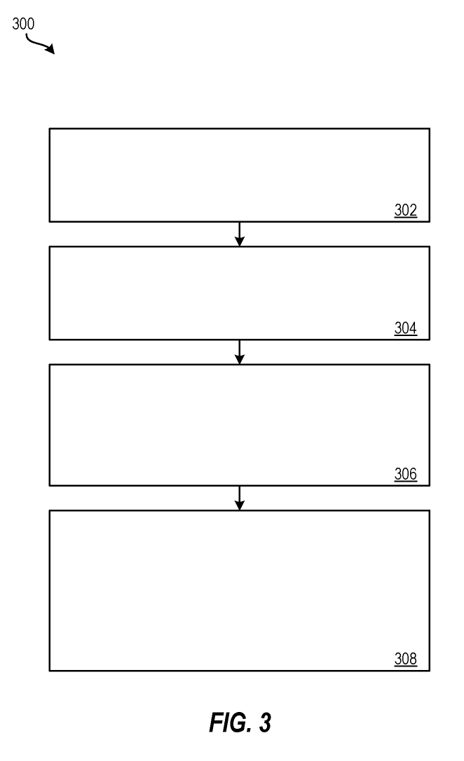

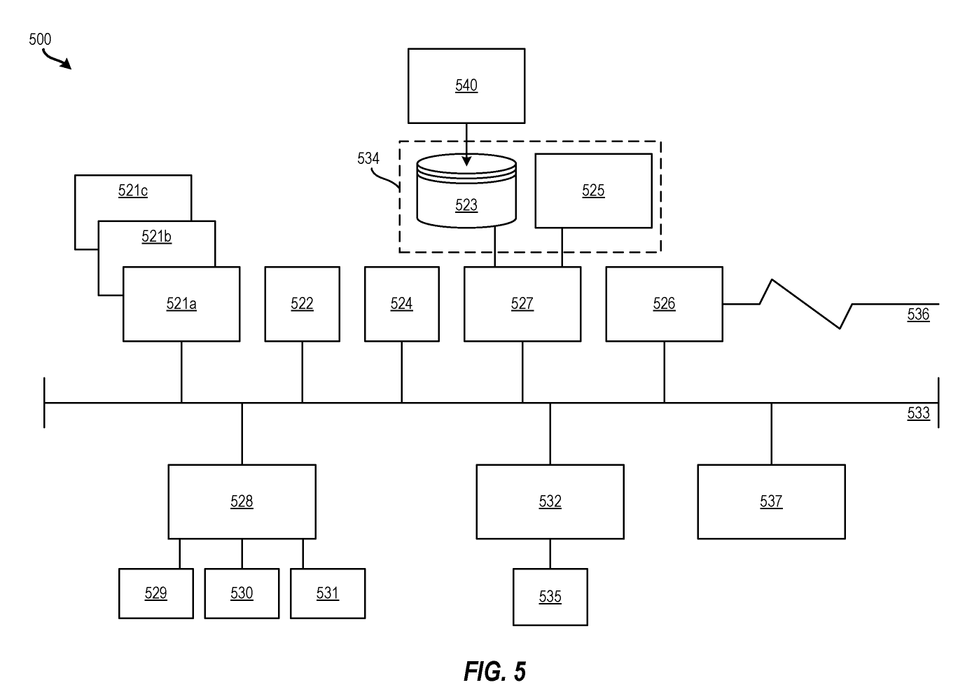

FIG. 3 depicts a flow diagram of a method for wake-up-word (WUW) detection, according to aspects of the present disclosure. The method 300 can be implemented, for example, by the processing system 100 of FIG. 1, by the processing system 500 of FIG. 5, or by another suitable processing system or processing device (e.g., the processing device 102, processor 521, etc.).

At block 302, the audio bridge engine 106 receives an utterance from the user 101. At block 304, the audio bridge engine 106 streams the utterance to each of a plurality of digital assistants (e.g., the phone assistant 111, the car assistant 113, the assistant 115), etc. In an example, at least one of the digital assistants is a phone-based digital assistant (i.e., a digital assistant running on or integrated into a phone, such as a smartphone) such as the phone assistant 111. In another example, at least one of the digital assistants is a vehicle-based digital assistant (i.e., a digital assistant embedded into a vehicle) such as the car assistant 113. The vehicle-based digital assistant (e.g., the car assistant 113) can control various systems in the vehicle. For example, the vehicle-based digital assistant can a control telematics system (e.g., to turn on lights, to change a climate control setting, etc.), an infotainment system (e.g., to turn on the radio, to enter a navigation command, etc.), and/or a communication system (e.g., to connect to a remote communication center).

At block 306, the sniffer engine 108 monitors an activity of at least one of the plurality of digital assistants to determine whether any of the plurality of digital assistants recognize the utterance as a WUW. When one of the digital assistants recognizes the utterance as a WUW, the assistant is considered active. In examples, monitoring the activity of at least one of the plurality of digital assistants includes detecting whether at least one of the plurality of digital assistants is performing a speech activity, a music activity, etc. In some examples, the activity of at least one of the plurality of digital assistants is provided directly by the at least one of the plurality of digital assistants. The activity can include an activity status (e.g., active, inactive, etc.) and an activity type (e.g., playing music, narrating speech, facilitating a phone call, etc.).

When one of the plurality of digital assistants recognizes the utterance as a WUW, the audio bridge engine 106 can disable streaming of additional utterances to the other digital assistants that did not recognize the utterance as a WUW at block 308. However, in some examples, the disabling can be based on an activity classification of the assistant that is active. For example, if the activity classifier 214 determines that the assistant (e.g., the phone assistant 111) is playing music, it may be desirable not to deactivate the other assistants in case the user 101 wishes to activate one of the other assistants (e.g., the car assistant 113, the assistant 115) by uttering one of those assistants' WUWs. This allows the other assistants to become active even while the already-active assistant is playing music, for example.

Additional processes also can be included, and it should be understood that the processes depicted in FIG. 3 represent illustrations and that other processes can be added or existing processes can be removed, modified, or rearranged without departing from the scope and spirit of the present disclosure.

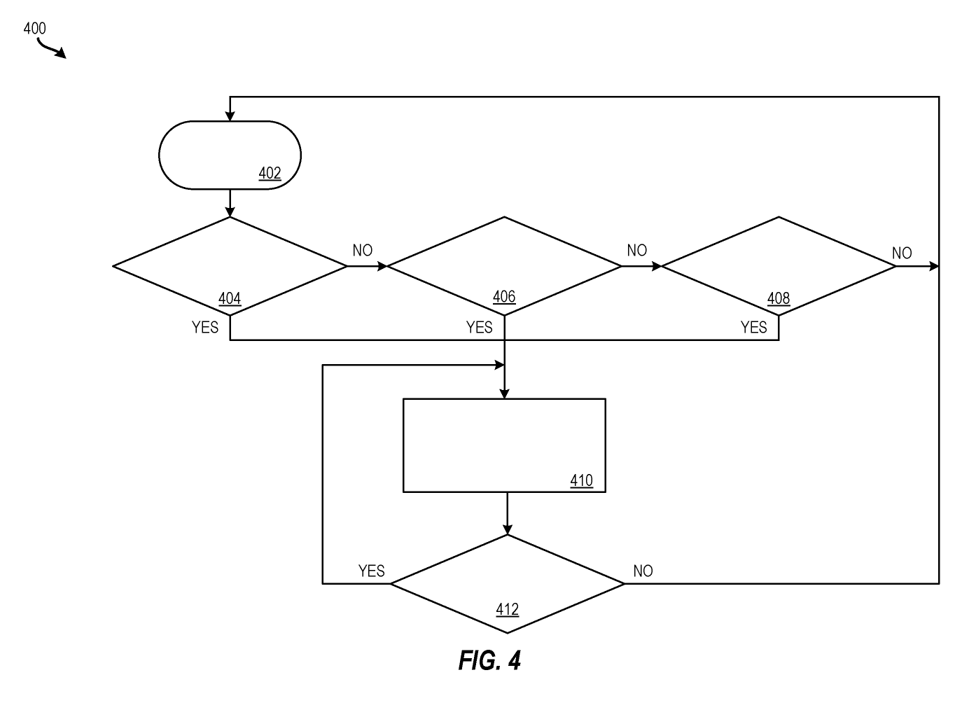

FIG. 4 depicts a flow diagram of a method for wake-up-word (WUW) detection, according to aspects of the present disclosure. The method 400 can be implemented, for example, by the processing system 100 of FIG. 1, by the processing system 500 of FIG. 5, or by another suitable processing system or device.

At block 402, the audio bridge engine 106 is active. At decision block 404, it is determined whether a first assistant is triggered by the utterance (i.e., wake-up-word). If not, at decision block 406, it is determined whether a second assistant is triggered by the utterance. If not, at decision block 408, it is determined whether a third assistant is triggered by the utterance. If not, the method 400 returns to block 402. However, in other examples, it could be determined whether an additional assistant(s) is triggered by the utterance.

If at any of decision blocks 404, 406, 408, it is determined that the respective assistant is triggered, the audio bridge engine 106 closes (or deactivates) the communicative connection to the other assistants so that only the one triggered by the utterance is active. For example, if at decision block 406 it is determined that the second assistant is triggered by the utterance, the audio bridge is closed to assistants 1 and 3 at block 410. The method 400 continues to decision block 412 where it is determined whether the current assistant is active (e.g., playing music, narrating text, providing navigational information, etc.). If so, the audio bridge engine 106 remains closed to other assistants. However, if the triggered assistant is no longer active as determined at decision block 412, the method 400 returns to block 402, and the audio bridge engine 106 is open to all of the assistants.

Additional processes also can be included, and it should be understood that the processes depicted in FIG. 4 represent illustrations and that other processes can be added or existing processes can be removed, modified, or rearranged without departing from the scope and spirit of the present disclosure.

As described herein, the present techniques can be implemented by various processing devices and/or processing systems. For example, FIG. 5 illustrates a block diagram of a processing system 500 for implementing the techniques described herein. In examples, processing system 500 has one or more central processing units (processors) 521a, 521b, 521c, etc. (collectively or generically referred to as processor(s) 521 and/or as processing device(s)). In aspects of the present disclosure, each processor 521 can include a reduced instruction set computer (RISC) microprocessor. Processors 521 are coupled to system memory (e.g., random access memory (RAM) 524) and various other components via a system bus 533. Read only memory (ROM) 522 is coupled to system bus 533 and can include a basic input/output system (BIOS), which controls certain basic functions of processing system 500.

Further illustrated are an input/output (I/O) adapter 527 and a network adapter 526 coupled to system bus 533. I/O adapter 527 can be a small computer system interface (SCSI) adapter that communicates with a hard disk 523 and/or other storage drive 525 or any other similar component. I/O adapter 527, hard disk 523, and storage device 525 are collectively referred to herein as mass storage 534. Operating system 540 for execution on processing system 500 can be stored in mass storage 534. A network adapter 526 interconnects system bus 533 with an outside network 536 enabling processing system 500 to communicate with other such systems.

A display (e.g., a display monitor) 535 is connected to system bus 533 by display adaptor 532, which can include a graphics adapter to improve the performance of graphics and general computation intensive applications and a video controller. In one aspect of the present disclosure, adapters 526, 527, and/or 532 can be connected to one or more I/O buses that are connected to system bus 533 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 533 via user interface adapter 528 and display adapter 532. A keyboard 529, mouse 530, and speaker 531 can be interconnected to system bus 533 via user interface adapter 528, which can include, for example, a Super I/O chip integrating multiple device adapters into a single integrated circuit.

In some aspects of the present disclosure, processing system 500 includes a graphics processing unit 537. Graphics processing unit 537 is a specialized electronic circuit designed to manipulate and alter memory to accelerate the creation of images in a frame buffer intended for output to a display. In general, graphics processing unit 537 is very efficient at manipulating computer graphics and image processing, and has a highly parallel structure that makes it more effective than general-purpose CPUs for algorithms where processing of large blocks of data is done in parallel.

Thus, as configured herein, processing system 500 includes processing capability in the form of processors 521, storage capability including system memory (e.g., RAM 524), and mass storage 534, input means such as keyboard 529 and mouse 530, and output capability including speaker 531 and display 535. In some aspects of the present disclosure, a portion of system memory (e.g., RAM 524) and mass storage 534 collectively store an operating system to coordinate the functions of the various components shown in processing system 500.

The descriptions of the various examples of the present disclosure have been presented for purposes of illustration, but are not intended to be exhaustive or limited to the embodiments disclosed. Many modifications and variations will be apparent to those of ordinary skill in the art without departing from the scope and spirit of the described techniques. The terminology used herein was chosen to best explain the principles of the present techniques, the practical application or technical improvement over technologies found in the marketplace, or to enable others of ordinary skill in the art to understand the techniques disclosed herein.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A computer-implemented method for wake-up-word detection, the method comprising:
receiving, by a processing device, an utterance from a user;
streaming, by the processing device, the utterance to each of a plurality of digital assistants;
monitoring, by the processing device, an activity of at least one of the plurality of digital assistants to determine whether any of the plurality of digital assistants recognize the utterance as a wake-up-word; and
responsive to determining that one of the plurality of digital assistants recognizes the utterance as a wake-up-word, disabling, by the processing device, streaming of additional utterances to a subset of the plurality of digital assistants that do not recognize the utterance as a wake-up-word.

2. The computer-implemented method of claim 1, wherein at least one of the plurality of digital assistants is a phone-based digital assistant.

3. The computer-implemented method of claim 1, wherein at least one of the plurality of digital assistants is a vehicle-based digital assistant.

4. The computer-implemented method of claim 3, wherein the vehicle-based digital assistant can control at least one of a telematics system of a vehicle, an infotainment system of the vehicle, and a communication system of the vehicle.

5. The computer-implemented method of claim 1, wherein monitoring the activity of at least one of the plurality of digital assistants further comprises detecting whether at least one of the plurality of digital assistants is performing a speech activity.

6. The computer-implemented method of claim 1, wherein monitoring the activity of at least one of the plurality of digital assistants further comprises detecting whether at least one of the plurality of digital assistants is performing a music activity.

7. The computer-implemented method of claim 1, wherein disabling the streaming of additional utterances to a subset of the plurality of digital assistants is based at least in part on an activity classification of the one of the plurality of digital assistants that recognize the utterance as a wake-up-word.

8. The computer-implemented method of claim 7, wherein streaming of additional utterances to the subset of the plurality of digital assistants is disabled when the activity classification is a first activity classification, and wherein streaming of additional utterances to the subset of the plurality of digital assistants is enabled when the activity classification is a second activity classification.

9. The computer-implemented method of claim 8, wherein the first activity classification is a phone call or text narration, and wherein the second activity classification is playing music.

10. The computer-implemented method of claim 1, further comprising:
responsive to determining that the one of the plurality of digital assistants that recognize the utterance as a wake-up-word is no longer active, enabling, by the processing device, streaming of additional utterances to the plurality of digital assistants.

11. The computer-implemented method of claim 1, wherein the activity of at least one of the plurality of digital assistants is provided by the at least one of the plurality of digital assistants, and wherein the activity comprises an activity status and an activity type.

12. A system for wake-up-word detection, the system comprising:
a memory comprising computer readable instructions; and
a processing device for executing the computer readable instructions for performing a method, the method comprising:
receiving, by the processing device, an utterance from a user;
streaming, by the processing device, the utterance to each of a plurality of digital assistants;
monitoring, by the processing device, an activity of at least one of the plurality of digital assistants to determine whether any of the plurality of digital assistants recognize the utterance as a wake-up-word; and
responsive to determining that one of the plurality of digital assistants recognize the utterance as a wake-up-word, disabling, by the processing device, streaming of additional utterances to a subset of the plurality of digital assistants that do not recognize the utterance as a wake-up-word.

13. The system of claim 12, wherein at least one of the plurality of digital assistants is a phone-based digital assistant.

14. The system of claim 12, wherein at least one of the plurality of digital assistants is a vehicle-based digital assistant.

15. The system of claim 14, wherein the vehicle-based digital assistant can control at least one of a telematics system of a vehicle, an infotainment system of the vehicle, and a communication system of the vehicle.

16. The system of claim 12, wherein monitoring the activity of at least one of the plurality of digital assistants further comprises detecting whether at least one of the plurality of digital assistants is performing a speech activity.

17. The system of claim 12, wherein monitoring the activity of at least one of the plurality of digital assistants further comprises detecting whether at least one of the plurality of digital assistants is performing a music activity.

18. The system of claim 12, wherein disabling the streaming of additional utterances to a subset of the plurality of digital assistants is based at least in part on an activity classification of the one of the plurality of digital assistants that recognize the utterance as a wake-up-word.

19. The system of claim 18, wherein streaming of additional utterances to the subset of the plurality of digital assistants is disabled when the activity classification is a first activity classification, wherein streaming of additional utterances to the subset of the plurality of digital assistants is enabled when the activity classification is a second activity classification, and wherein the first activity classification is a phone call or text narration, and wherein the second activity classification is playing music.

20. A computer program product for wake-up-word detection, the computer program product comprising:
a computer readable storage medium having program instructions embodied therewith, the program instructions executable by a processing device to cause the processing device to perform a method comprising:
receiving, by the processing device, an utterance from a user;
streaming, by the processing device, the utterance to each of a plurality of digital assistants;
monitoring, by the processing device, an activity of at least one of the plurality of digital assistants to determine whether any of the plurality of digital assistants recognize the utterance as a wake-up-word; and
responsive to determining that one of the plurality of digital assistants recognize the utterance as a wake-up-word, disabling, by the processing device, streaming of additional utterances to a subset of the plurality of digital assistants that do not recognize the utterance as a wake-up-word.
